(19) United States
(12) Patent Application Publication
(10) Pub. No.: US 2015/0242109 A1
(43) Pub. Date: Aug. 27, 2015

(54) MEASURING DEVICE AND A MEASURING METHOD WITH USER DIALOGS CAPABLE OF BEING ADAPTED IN SIZE AND INFORMATION CONTENT

(71) Applicant: Rohde & Schwarz GmbH & Co. KG, Munich (DE)

(72) Inventors: Rene MÜSSIG, Grafing (DE); Friedrich REICH, Stadtbergen (DE); Ferdinand MAYET, Munich (DE)

(21) Appl. No.: 14/631,364

(22) Filed: Feb. 25, 2015

(30) Foreign Application Priority Data
Feb. 25, 2014 (DE) 10 2014 203 346.2

(51) Int. Cl. G06F 3/0484; G06F 3/0488; G06F 3/0486; G06F 3/0482; G06F 3/0481

(52) U.S. Cl. CPC G06F 3/04847; G06F 3/0482; G06F 3/0481; G06F 3/04845; G06F 3/0486; G06F 3/04883

(57) ABSTRACT

A measuring device contains a control unit, a display unit and an input unit. The input unit serves in this context for the input of user entries. The control unit is accordingly embodied to display a user dialog with several dialog elements by means of the display unit. Furthermore, the control unit provides a dialog-processing unit which is embodied to specify dialog elements to be displayed in the user dialog on the basis of a first user entry which specifies a size of the display of the user dialog.

### CROSS-REFERENCE TO RELATED APPLICATION

The present application claims priority to German Patent Application No. 10 2014 203 346.2 filed on Feb. 25, 2014, the entire contents of which are herein incorporated by reference.

### FIELD OF THE INVENTION

The invention, according to various embodiments described herein, relates to a measuring device and a measuring method which use user dialogs for the input and output of information. In particular, the invention relates to a measuring device and a measuring method in which the size of the display and the information content of the user dialogs are adaptable.

### DISCUSSION OF THE BACKGROUND

In conventional measuring devices, a display of numerous items of information, for example, relating to the present measurement, is provided in a user dialog. Furthermore, settings can be activated, for example, by means of an entry field. Descriptive texts, information graphics etc. are also frequently contained in such user dialogs. As a result, the user dialogs can occupy a large part of a display of a measuring device. This makes a simultaneous observation of a measurement signal on the display significantly more difficult.

Traditionally, user dialogs of a measuring device can be adapted manually; however, for this purpose, a dialog editor which allows a targeted manipulation, including an addition and/or removal of dialog elements, must be used. This is excessively effort intensive for an inexperienced user.

### SUMMARY OF THE INVENTION

According to one embodiment, a measuring device and a measuring method which allow a simple reduction in the size of user dialogs, but which, in this context, ensure that relevant dialog elements are always displayed, is provided.

In this context, a measuring device according to one aspect of the invention may contain a control unit, a display unit and an input unit. Accordingly, the input unit serves for the input of user entries. The control unit may be embodied in this context to display a user dialog with several dialog elements by means of the display unit. Furthermore, the control unit may provide a dialog-processing unit which is embodied to specify dialog elements to be displayed in the user dialog on the basis of a first user entry which specifies a size of the display of the user dialog. This means that different dialog elements may be displayed dependent upon the size of the display of the user dialog set by the user by means of the user entry.

For example, if a large display of a user dialog is selected, less important dialog elements, such as descriptive texts or information graphics can also be displayed. By contrast, if a very small size of the display of the user dialog is specified by the user, only the most important dialog elements, such as parameters to be set and output parameters may be displayed. In this manner, a visually clear operation may be achieved at the same time as making available the most relevant parameters.

In one embodiment, the dialog-processing unit may be embodied in this context to specify a first selection of dialog elements in the case of a first user entry which determines a first size of the display of the user dialog, and to specify a second selection of dialog elements in the case of a first user entry which determines a second size of the display of the user dialog. In this case, the first size may be larger than the second size and the first selection of dialog elements may contain a larger number of dialog elements than the second selection of dialog elements. Accordingly, in the case of an enlargement of the display of the user dialog, an increase in the number of displayed dialog elements may be achieved, and, in the case of a reduction in the size of the display of the user dialog, a reduction in the number of dialog elements displayed may be achieved. As a result, visual clarity can be further improved.

In another embodiment, the dialog-processing unit may further be embodied to specify a third selection of dialog elements in the case of a first user entry which determines a third size of the display of the user dialog. In this case, the second size may be larger than the third size and the second selection of dialog elements may contain a larger number of dialog elements than the third selection of dialog elements.

Alternatively, according to yet another embodiment, an infinite variation of the size of the display of the user dialog can be implemented. In this context, the number of dialog elements displayed is also always increased in the case of an enlargement of the display, while the number of dialog elements displayed is also reduced in the case of a reduction in the size of the display. Here also, an improvement in the clarity of the display is achieved.

In one embodiment, the control unit provides a dialog databank. This may be embodied to store dialog elements and in each case at least one associated relevance-parameter. The dialog-processing unit may then be embodied to take the relevance-parameters of the dialog elements into consideration in determining the respective selection of dialog elements to be displayed. Accordingly, in a simple and hardware-saving manner, it is possible to store with every dialog element how important a display of the respective dialog element is. Accordingly, for example, a high relevance-parameter indicates a high importance and a low relevance-parameter indicates a low importance. In particular, in the case of a reduction in the size of the display of the user dialog, dialog elements which provide a low importance, and accordingly in this example provide a low relevance-parameter, are hidden first.

In yet another embodiment, the relevance-parameters of the dialog elements in this context may dependent upon a degree of experience of a user and/or dependent upon a preference of a user and/or dependent upon a present user and/or may be predefined and/or adjustable by a user. Alternatively or additionally, the dialog-processing unit may be embodied to determine the relevance-parameters on the basis of a user behavior and/or on the basis of an operating history of the dialog element. In this manner, relevance-parameters of the dialog elements can be determined in a very flexible manner. In particular, it is possible to take into consideration the preferences and capabilities of individual users, thereby achieving an optimal operating experience.

For example, in the case of an inexperienced user, the relevance-parameter of an explanatory text can be set high, so that the inexperienced user is always shown the explanatory text. An adjustment option for a parameter used only rarely could be provided with a low relevance-parameter for such an inexperienced user, so that the adjustment option of this parameter is hidden in the case of a reduction in size of the user dialog. Conversely, in the case of a very experienced user, descriptive texts can generally be provided with a low relevance-parameter, since the experienced user no longer requires these texts. In this manner, in the case of an experienced user, the dialogs can contain a larger number of input and output parameters.

In another embodiment, the dialog-processing unit is further embodied to set a relevance-parameter of a dialog element to a maximum relevance if the associated dialog element is presently selected by a user through a user entry. This relates particularly to the case that the respective dialog element is disposed within the mouse focus. The allocation of the maximum relevance may indicate that the corresponding dialog element is not hidden even in the case of a reduction in size of the display of the user dialog.

In one embodiment, the dialog-processing unit may be embodied to implement a scaling of the display of the user dialog with the displayed dialog elements on the basis of a second user entry which specifies a size of the display of the user dialog. That is to say, in this case, no dialog elements may be included and excluded, but the size of the overall display of the user dialog and the dialog elements may be changed. Accordingly, an improvement in clarity can be achieved without a loss of information displayed.

In yet another embodiment, the dialog elements may input elements, such as selection elements or entry fields and/or output elements, such as information texts or information graphics or parameter displays. Accordingly, a very good visual clarity can be achieved with a very flexible design of the dialogs.

In one embodiment, the display unit in this context may contain a touch-sensitive screen. In this case, the input unit may be embodied to detect and process user entries by means of the touch-sensitive screen. Accordingly, the first user entry may be a first gesture, preferably a displacement of a frame of the user dialog at one corner of the frame on the touch-sensitive screen. The second user entry in this context may be a second gesture, preferably a displacement of a frame of the user dialog at a straight side on the touch-sensitive screen. Accordingly, a very simple control of the measuring device is achieved.

A method according to another aspect of the invention serves for the control of a measuring device. In this context, a user dialog with several dialog elements may be displayed by the measuring device. On the basis of a first user entry which specifies a size of the display of the user dialog, dialog elements to be displayed in the user dialog may be automatically specified. Accordingly, a good visual clarity and a simple operation are guaranteed.

### BRIEF DESCRIPTION OF THE DRAWINGS

In the following, the invention is described on the basis of the drawings which present an advantageous exemplary embodiment of the invention by way of example only. The drawings show:

FIG. 1 a measuring device in a block-circuit diagram, according to one embodiment;

FIG. 2 a first detail view of the measuring device in a block-circuit diagram, according to one embodiment;

FIG. 3 a first and second view of a display unit of the measuring device, according to one embodiment;

FIG. 4 a third and a fourth view of a display unit of the measuring device, according to one embodiment; and

FIG. 5 an exemplary embodiment of the method in a flow diagram, according to one embodiment.

### DETAILED DESCRIPTION OF THE DRAWINGS

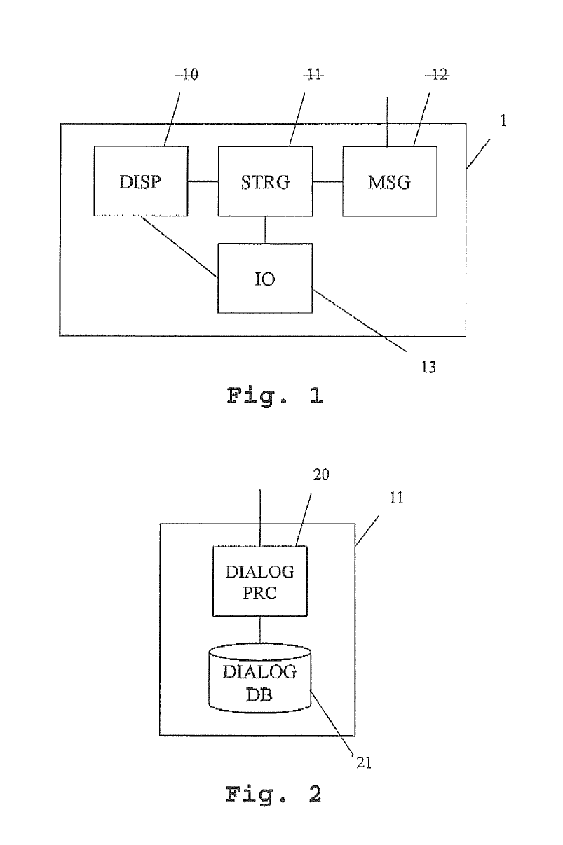

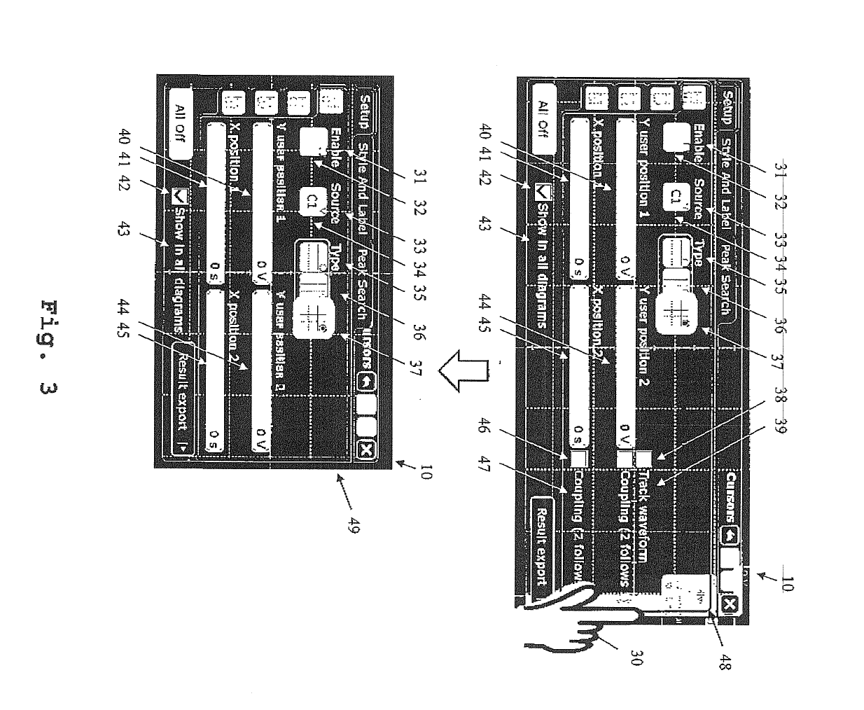

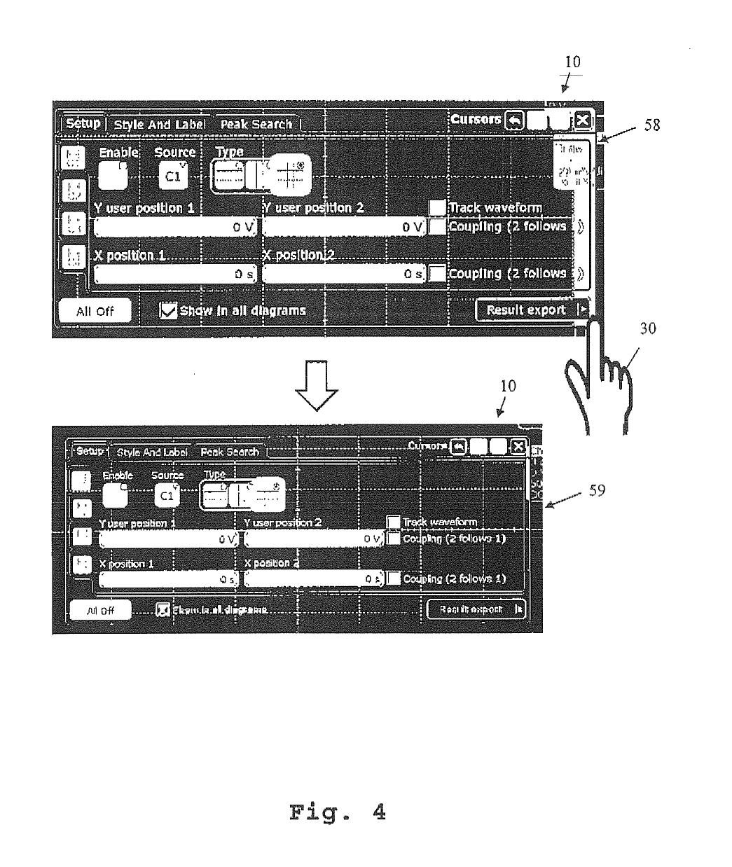

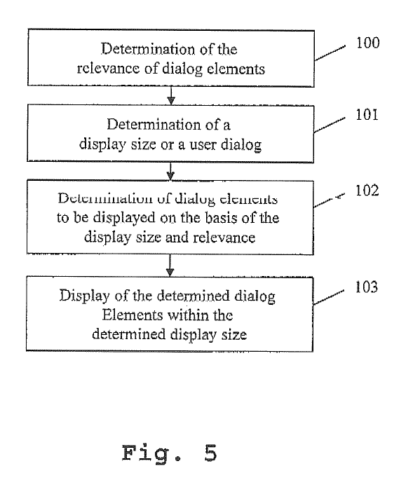

Initially, with reference to FIGS. 1 and 2, the general object and functioning of an embodiment of the measuring device is explained. With reference to FIGS. 3 and 4, the functioning of the embodiment will then be explained. Finally, the functioning of the embodiment of the method will be explained with reference to FIG. 5. The presentation and description of identical elements in similar drawings has not been repeated in some cases.

FIG. 1 shows a measuring device 1 according to one embodiment. The measuring device 1 in this context contains a display unit 10 which is connected to a control unit 11. The control unit 11 is connected in turn to a measuring unit 12 and an input unit 13. Additionally, the input unit 13 is connected to the display unit 10. In this context, the measuring unit 12 is additionally connected, during the implementation of a measurement, to a device under test. The device under test can be, for example, an oscilloscope, a signal analyzer, a signal generator, a network analyzer etc.

In this context, the control unit 11 controls all of the other components connected to it. In particular, the control unit 11 controls the display unit 10 in such a manner that, in addition to measurement results, the latter displays at least one user dialog with several dialog elements. An interaction with the user takes place by means of a user dialog. A user dialog can be a dedicated window displayed on the display unit 10, but also a status bar at an edge of the display unit 10. Further details of the embodiment of the exemplary embodiment of the measuring device 1 according to the invention will be given with reference to FIG. 2.

FIG. 2 shows a detail view of the construction of the control unit 11 of the measuring device according to the embodiment from FIG. 1 as a block-circuit diagram. The control unit 11 in this context contains a dialog-processing unit 20 and a dialog databank 21 which is connected to the dialog-processing unit 20. For reasons of clarity, the presentation of further components of the control unit 11 which serve for the control of the actual measurement, have not been provided here. These further components are without relevance for the present invention.

The dialog-processing unit 20 in this context serves for the control of the display of the user dialogs on the display unit 10. In particular, the dialog-processing unit 20 serves to determine with which size and with which dialog elements the user dialogs are displayed on the display unit 10. For this purpose, the dialog-processing unit 20 accesses the dialog databank 21. Various dialog elements are stored in the dialog databank 21. These can be input elements, such as selection elements or entry fields and/or output elements, such as information texts or information graphics or parameter displays. Furthermore, one or more user dialogs with corresponding dialog elements are stored in the dialog databank 21.

In addition to the dialog elements, relevance-parameters are stored in the dialog databank 21. That is, at least one relevance-parameter is assigned to every dialog element. The relevance-parameters determine the relevance of the respective dialog element. For example, a high value of the assigned relevance-parameter can indicate a high relevance and a low value of the assigned relevance-parameter can indicate a low relevance of the respective dialog element.

In this context, if a first size of display of the user dialog has been determined by means of a user entry, the dialog-processing unit 20 displays the at least one user dialog on the display unit 10 with a first size and a first selection of dialog elements. If a second size is determined by the user entry, the dialog-processing unit 20 displays the user dialog with a second size and a second selection of dialog elements. In this context, the first size is larger than the second size and the first selection of dialog elements larger than the second selection of dialog elements. That is, if a large display of the user dialog is requested by a user by means of a first user entry, for example, a gesture on the touch-sensitive screen, the dialog-processing unit 20 displays the user dialog in this first size and selects a corresponding number of dialog elements which are to be shown with a given size. However, if a user selects a relatively smaller second size by means of a first user entry, the dialog-processing unit 20 displays the user dialog in a smaller size and therefore reduces the number of displayed dialog elements correspondingly.

A use of a third size and a third selection of dialog elements each of which is smaller than the second size respectively the second selection, is also conceivable. An infinite adjustability of the size of the display of the user dialog is also possible.

In selecting the user dialogs to be displayed, the dialog-processing unit 20 accesses the relevance-parameters which are stored in the dialog databank 21. If the size of the display of the user dialog selected by the user does not allow a display of all of the dialog elements associated with the user dialog, the dialog-processing unit 20 selects from the dialog elements associated with the user dialog initially those of greatest relevance and arranges these in the user dialog. The corresponding dialog elements are arranged in the user dialog in descending order of the stored relevance-parameters of the dialog elements. As soon as the available space within the user dialog has been exhausted, dialog elements of a lower order of relevance are omitted, that is, they are not displayed in the user dialog.

The relevance-parameters of the dialog elements in this context are optionally dependent upon the degree of experience of a user. For example, for an experienced user, an explanatory text may be of low relevance, while for an inexperienced user precisely such an explanatory text has a high relevance. The relevance-parameters can also be stored in the dialog databank 21 dependent upon a preference of a user. A separate storage of relevance-parameters for different users is also optionally possible. In this case, the user logs on to the measuring device, whereupon the measuring device uses the relevance-parameters stored for the respective user. Furthermore, the relevance-parameters can be predefined by the manufacturer. A direct adjustability of the relevance-parameters by a user is also conceivable. Furthermore, the dialog-processing unit can optionally determine the relevance-parameters on the basis of a user behavior or on the basis of an operating history of the dialog elements. Accordingly, the dialog-processing unit 20 establishes, for example, how frequently a given dialog element is actually used by a user and, on this basis, determines the relevance-parameter.

In particular, if a user has just implemented an entry, for example, in an entry cell, and the corresponding dialog element is still selected, or respectively by a mouse focus being disposed over the associated dialog element, the dialog-processing unit 20 can optionally provide the corresponding dialog element with a relevance-parameter of maximum relevance. This ensures that the parameters just modified or respectively the dialog element disposed within the mouse focus is also not hidden in the case of the reduction in size of the display of the user dialog. In the extreme case, the user dialog can be reduced in size until only this one element remains in the user dialog.

Optionally, the dialog-processing unit is further embodied not to implement any increase or reduction in the number of dialog elements on the basis of a second user entry which specifies a size of the display of the user dialog, but only to scale the user dialog with all of the displayed dialog elements. In this manner, users can achieve an increase in information density dependent upon their required comfort level and, especially, dependent upon a display size of the dialog elements which is still acceptable for the user.

The display unit 10 can, especially, be a touch-sensitive screen. In this case, the touch-sensitive screen is additionally used in collaboration with the input unit 13 for the input of user entries. In particular, the first user entry and the second user entry can be entered as a first and second gesture on the touch-sensitive screen.

FIG. 3 shows two displays of the display unit 10 from FIG. 1. In an upper view, on the display unit 10, a user dialog 48 is shown with a plurality of dialog elements 31-47. The dialog elements 31, 33, 35, 39, 43 and 47 are information texts. The dialog elements 32, 34, 38, 42 and 46 are selection elements. The dialog elements 40, 41, 44 and 45 are entry fields. The dialog elements 36 and 37 are information graphics. As already described, at least one relevance-parameter is assigned to every dialog element 31-47. Now, if the user performs a first user entry with her/his hand 30, in this case an operating gesture on the touch-sensitive screen, the dialog-processing unit 20 implements a new specification of the dialog elements to be displayed on the basis of the relevance-parameters of the dialog elements 31-37.

The first user entry here is, for example, a displacement of the straight portion of the frame of the user dialog to the left. In this example, the dialog elements 38, 39, 46 and 47 are hidden. This is clearly evident in the lower view of FIG. 3.

FIG. 4 shows a third and fourth view of the display unit 10 of the measuring device 1 according to the embodiment from FIG. 1. Here, a scaling through a second user entry, for example a displacement of the corner of the frame of the user dialog is shown. A user dialog 58 is illustrated here, which is initially displayed in a first relatively larger size in the upper view, and as a relatively smaller user dialog 59 in the lower view after the second user entry. The numbering and referencing of the individual operating elements has been omitted here for reasons of clarity.

Optionally, the dialog-processing unit 20 from FIG. 2 can additionally implement both functions at the same time—a change in the number of displayed dialog elements and a scaling of the user dialog. This can be input, for example, through a third user entry, for example, a further operating gesture on the touch-sensitive screen.

Finally, FIG. 5 shows a method according to one embodiment. In a first step 100, a relevance of dialog elements is determined. This can take place in the factory in a predetermined manner, but also through user settings or through adaptive learning of the measuring device. In a second step 101, a display size of a user dialog is determined by a user entry. A third step 102 determines automatically which dialog elements are to be displayed. This determination is implemented dependent upon the display size selected by the user and upon the previously determined relevance of the dialog elements. Particularly relevant dialog elements are displayed, while less relevant dialog elements are hidden to the extent that the selected display size is inadequate for their display. In a fourth step 103, the determined dialog elements are displayed in the determined display size.

The invention is not restricted to the exemplary embodiment presented. In particular, the present invention can be used with extremely diverse types of measuring devices. Advantageously, all of the features described above or features shown in the drawings can be combined with one another arbitrarily within the scope of the invention.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A measuring device with a control unit, a display unit and an input unit for the input of user entries,
wherein the control unit is embodied to display a user dialog with several dialog elements by means of the display unit,
wherein the control unit provides a dialog-processing unit, which is embodied to specify dialog elements to be displayed in the user dialog on the basis of a first user entry which specifies a size of the display of the user dialog.

2. The measuring device according to claim 1,
wherein the dialog-processing unit is embodied to specify a first selection of dialog elements in the case of a first user entry which determines a first size of the display of the user dialog, and to specify a second selection of dialog elements in the case of a first user entry which determines a second size of the display of the user dialog,
wherein the first size is larger than the second size and
wherein the first selection of dialog elements contains a larger number of dialog elements than the second selection of dialog elements.

3. The measuring device according to claim 2,
wherein the dialog-processing unit is embodied to specify a third selection of dialog elements in the case of a first user entry which determines a third size of the display of the user dialog,
wherein the second size is larger than the third size, and
wherein the second selection of dialog elements contains a larger number of dialog elements than the third selection of dialog elements.

4. The measuring device according to claim 1,
wherein the control unit contains a dialog databank, which is embodied to store dialog elements and in each case at least one associated relevance-parameter, and
wherein the dialog-processing unit is embodied to take the relevance-parameters of the dialog elements into consideration in determining the respective selection of dialog elements to be displayed.

5. The measuring device according to claim 4,
wherein the relevance-parameters of the dialog elements are dependent upon a degree of experience of a user and/or dependent upon a preference of a user and/or dependent upon a present user and/or are predefined and/or adjustable by a user, and/or
wherein the dialog-processing unit is embodied to determine the relevance-parameters on the basis of a user behavior and/or on the basis of an operating history of the dialog element.

6. The measuring device according to claim 4,
wherein the dialog-processing unit is embodied to set a relevance-parameter of a dialog element to a maximum relevance if the associated dialog element is selected by a user through a user entry, especially if a mouse focus is disposed on the associated dialog element.

7. The measuring device according to claim 1,
wherein the dialog-processing unit is embodied to implement a scaling of the display of the user dialog with the displayed dialog elements on the basis of a second user entry which specifies a size of the display of the user dialog.

8. The measuring device according to claim 1,
wherein the dialog elements are input elements such as selection elements or entry fields, and/or output elements such as information texts or information graphics or parameter displays.

9. The measuring device according to claim 1,
wherein the display unit contains a touch-sensitive screen,
wherein the input unit is embodied to detect and process user entries by means of the touch-sensitive screen,
wherein the first user entry is a first gesture, preferably a displacement of a frame of the user dialog at a corner of the frame on the touch-sensitive screen,
wherein the second user entry is a second gesture, preferably a displacement of a frame of the user dialog at a straight side on the touch-sensitive screen.

10. A method for controlling a measuring device,
wherein a user dialog with several dialog elements is displayed on a display unit,
wherein dialog elements to be displayed in the user dialog are specified on the basis of a first user entry which specifies a size of the display of the user dialog.

11. The method according to claim 10,
wherein in the case of a first user entry which determines a first size of the display of the user dialog, a first selection of dialog elements is specified,
wherein, in the case of a first user entry which determines a second size of the display of the user dialog, a second selection of dialog elements is specified,
wherein the first size is larger than the second size, and that the first selection of dialog elements contains a larger number of dialog elements than the second selection of dialog elements.

12. The method according to claim 11,
wherein in the case of a first user entry which determines a third size of the display of the user dialog, a third selection of dialog elements is specified,
wherein the second size is larger than the third size, and
wherein the second selection of dialog elements contains a larger number of dialog elements than the third selection of dialog elements.

13. The method according to claim 10,
wherein dialog elements and in each case an associated relevance-parameter are stored in a dialog databank, and
wherein the relevance-parameters of the dialog elements are taken into consideration in determining the respective selection of dialog elements to be displayed.

14. The method according to claim 13,
wherein the relevance-parameters of the dialog elements are dependent upon a degree of experience of a user and/or dependent upon a preference of the user and/or dependent upon a present user and/or are predefined and/or adjustable by a user, and/or
wherein the relevance-parameters are determined on the basis of a user behavior and/or on the basis of an operating history of the dialog element.

15. The method according to claim 13,
wherein a relevance-parameter of a dialog element is set to a maximum relevance if the associated dialog element is selected by a user through a user entry, especially if a mouse focus is placed over the associated dialog element.

16. The method according to claim 10,
wherein a scaling of the display of the user dialog with the displayed dialog elements is implemented on the basis of a second user entry which specifies a size of the display of the user dialog.

17. The method according to claim 10,
wherein the dialog elements are input elements such as selection elements or entry fields, and/or output elements such as information texts or information graphics or parameter displays.

18. The method according to claim 10,
wherein the display unit contains a touch-sensitive screen,
wherein user entries are detected and processed by means of the touch-sensitive screen,
wherein the first user entry is a first gesture, preferably a displacement of a frame of the user dialog at a corner of the frame on the touch-sensitive screen, and
wherein the second user entry is a second gesture, preferably a displacement of a frame of the user dialog at a straight side on the touch-sensitive screen.
